(19) United States
(12) Patent Application Publication
(10) Pub. No.: US 2010/0068982 A1
(43) Pub. Date: Mar. 18, 2010

(54) FORCED VENTILATION SYSTEM FOR THE PASSENGER COMPARTMENT OF AN AUTOMOBILE, AND CORRESPONDING DASHBOARD

(75) Inventors: Pierre GUERREIRO, SAINT GRATIEN (FR); Claude BOURBON, MOLIN (FR)

Correspondence Address: YOUNG & THOMPSON, 209 Madison Street, Suite 500, Alexandria, VA, 22314, US

(73) Assignees: FAURECIA INTERIEUR INDUSTRIE, NANTERRE (FR); BOURBON AUTOMOBILE, ST LUPICIN (FR)

(21) Appl. No.: 12/304,944

(22) PCT Filed: Apr. 19, 2007
(86) PCT No.: PCT/FR07/00660

§ 371 Date: May 26, 2009

(30) Foreign Application Priority Data
Jun. 16, 2006 (FR) 06 05391

(51) Int. Cl. B60H 1/34

(52) U.S. Cl. 454/152

(57) ABSTRACT

This forced ventilation system for the passenger compartment of an automobile includes an aerator (2) guiding at least one air flow toward the passenger compartment, with the aerator including a fixed downstream screen (8) masking the upstream of the aerator. The screen (8) includes, in its current region (16A), openings (18) defining a large number of extended sections (22, 24, 28, 30, 32, 42, 44, 46), with the sections (22, 24, 28, 30, 32, 42, 44, 46) being oriented in at least two different directions.

The present invention relates to a forced ventilation system for the passenger compartment of a motor vehicle, of the type comprising an aerator guiding at least one stream of air towards the passenger compartment, the aerator comprising a downstream fixed grille masking the upstream portion of the aerator.

Normal ventilation systems comprise aerators which open out in the passenger compartment of the vehicle. Each aerator is generally provided with fixed or movable blades enabling the stream of air to be oriented in a particular direction.

These aerators, especially when they open out via the dashboard, do not fit in with the decor of the latter and are not aesthetically pleasing.

In addition, when the aerators are mounted to be movable, there is a clearance line around each aerator. This clearance line is likewise not of an aesthetically pleasing nature.

The object of the invention is to provide a ventilation system which improves the aesthetic appearance without substantially impairing the directivity of the aerator or introducing a substantial loss of pressure.

To that end, the invention relates to a ventilation system of the above-mentioned type, characterized in that the grille comprises, in its main region, openings which define a large number of elongate portions, the portions being oriented in at least two different directions.

According to particular embodiments, the ventilation system may comprise one or more of the following features:
the overall passage surface area of the portions oriented in a first direction is substantially equal to the overall passage surface area of the portions oriented in a second direction;
two of the directions form between them an angle greater than or equal to 45°;
the total passage surface area of the openings in the main region is greater than or equal to 50% of the surface area of the main region;
the portions have a width greater than or equal to 2 mm and a length greater than or equal to 3 mm;
substantially any portion extending in one direction is adjacent to a portion extending in another direction;
the aerator also comprises substantially circular openings, the average diameter of the circular openings being greater than or equal to 3 mm;
the grille continues with a similar pattern of openings as the decorative trim of a dashboard of the vehicle;
the aerator comprises means for orienting the stream of air, for example a blade or a nozzle, upstream of the grille, the means for orienting the stream of air being spaced from the grille.

The invention relates also to a dashboard of a motor vehicle comprising a ventilation system as defined above.

The invention will be better understood on reading the following description which is given purely by way of example and with reference to the drawings, in which:

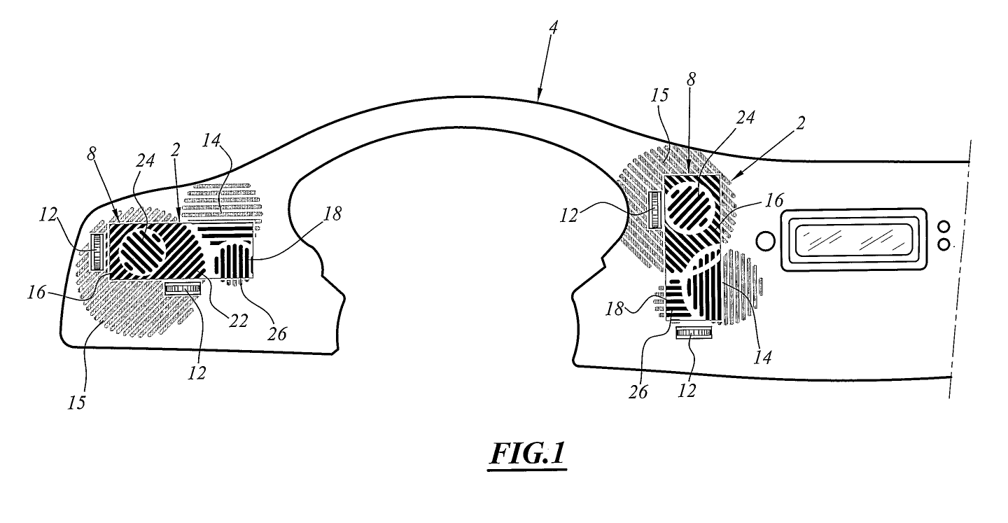

FIG. 1 is a schematic front view of an example of a dashboard comprising a ventilation system according to the invention;

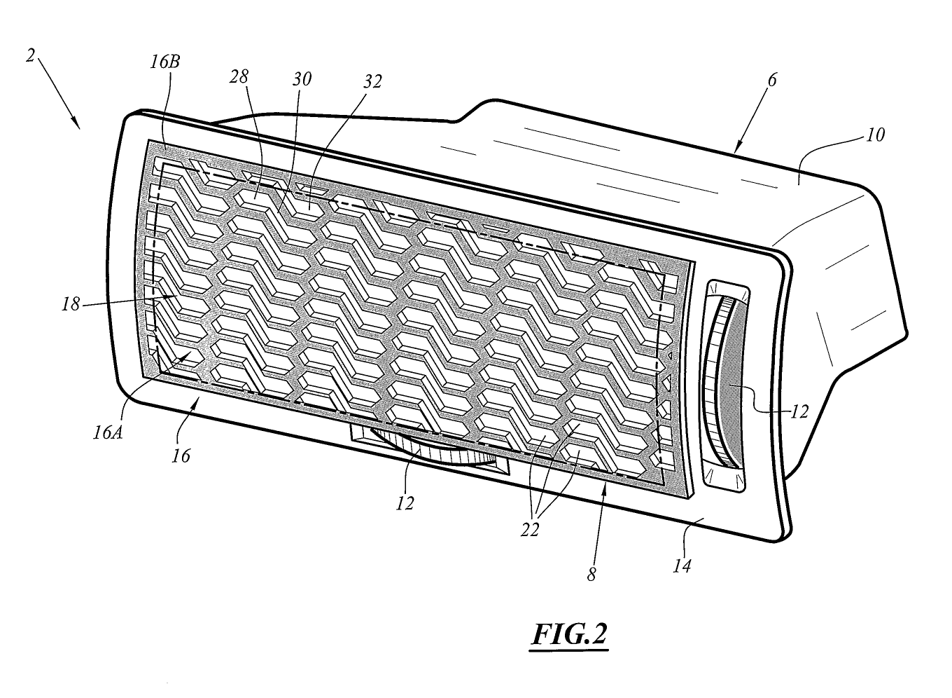

FIG. 2 is a schematic perspective view of an aerator of a ventilation system according to the invention which can be integrated in the dashboard of FIG. 1;

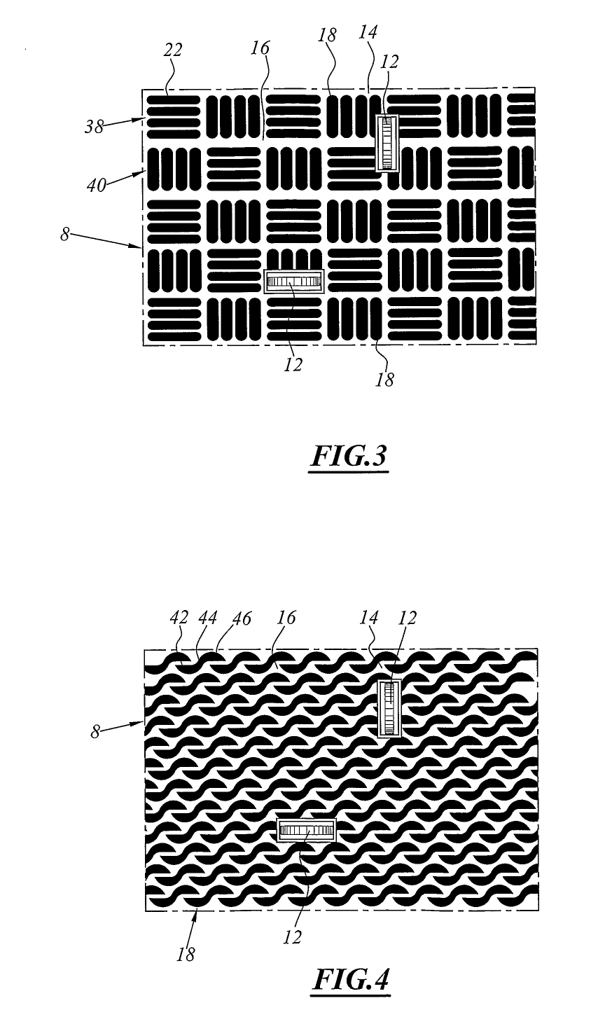

FIGS. 3 to 6 are schematic front views of four examples of a fixed grille of a ventilation system according to the invention.

In the embodiment of FIG. 1, the ventilation system according to the invention comprises a plurality of aerators 2 integrated in the dashboard 4 of the vehicle. Each aerator 2 guides and orients a stream of air produced upstream by the ventilation system and opens out in the passenger compartment of the vehicle. Two aerators can be seen in FIG. 1.

In the example of FIG. 2, each aerator 2 comprises an upstream casing 6 for guiding, blocking off and/or orienting the stream of air, and a fixed grille 8 downstream of the body 10 of the casing 6. The grille 8 is fixed relative to the passenger compartment of the vehicle.

The casing 6 is a conventional casing of known type. It is, for example, provided with movable blades, one or more movable nozzles, or with any other means for orienting the stream of air passing through the casing 6.

As illustrated in FIG. 2, the casing 6 also comprises two wheels 12 of known type which are mounted rotatably on the body 10 of the casing while projecting towards the passenger compartment. The wheels 12 are connected to the linkage of the casing 6 in order to operate, for example, movable blades, movable nozzles, any other movable air-guiding means, or also a flap for blocking off the stream of air. However, it is possible, for example, to replace the wheels 12 by electrical control means.

In the example of FIG. 2, the fixed grille 8, inserted in a support edging 14 of the casing 6, comprises an active region 16 in which openings 18 are formed for the passage of the air through the grille 8. The region 16 itself comprises a main region 16A having openings 18 which are all identical, and a marginal region 16B which is not perforated or which has openings having different configurations.

In the embodiment illustrated in FIG. 1, the support edging 14 comprises openings 18 similar to the openings 18 formed in the main region 16A of the grille 8. Thus, the aesthetic appearance of the aerator is improved.

Furthermore, the support edging 14 continues as the decorative trim of the dashboard 4. The aesthetic appearance of this decorative trim is therefore adapted to the appearance of the grille so that the position of the aerators 2 is masked. The decorative trim may extend in the desired directions and over the desired distances, starting from the grille, to obtain very varied desired aesthetic effects for the whole of the dashboard. Thus, in the example of FIG. 1, two aerators adjacent to the instrument panel are each associated with four circular regions 15 which have different diameters and which overlap the aerators or are enclosed therein.

All of the fixed grilles 8, their edgings 14 and the decorative trim are, for example, moulded in one piece from a plastics material to form the visible covering of the dashboard, or a portion thereof. In a variant, each moulded piece may constitute only one grille 8 with its edging 14 and the corresponding decorative trim.

The aerator 2 may comprise a plurality of movable blades of known type. These blades enable the stream of air to be oriented with good directivity and without causing any substantial loss of pressure. The fixed grille 8 masks these blades.

The movable blades may be spaced from the grille 8. Thus, the grille 8 is freed from mechanical constraints with respect to the blades. The geometry of the fixed grille 8 can then be selected independently of the geometry of the movable blades.

In the various embodiments of the invention, the openings 18 of the main region 16A of the grille 8 define a large number of portions 22 which are elongate in at least two directions, the two directions preferably forming between them an angle greater than or equal to 45°.

The overall passage surface area of the portions 22 oriented in a first direction is advantageously substantially equal to the overall passage surface area of the portions 22 oriented in a second, different, direction. Thus, the influence of the grille 8 on the directivity of the stream of air is minimized.

Possible different geometries for the grille 8 are illustrated in FIGS. 1 to 6.

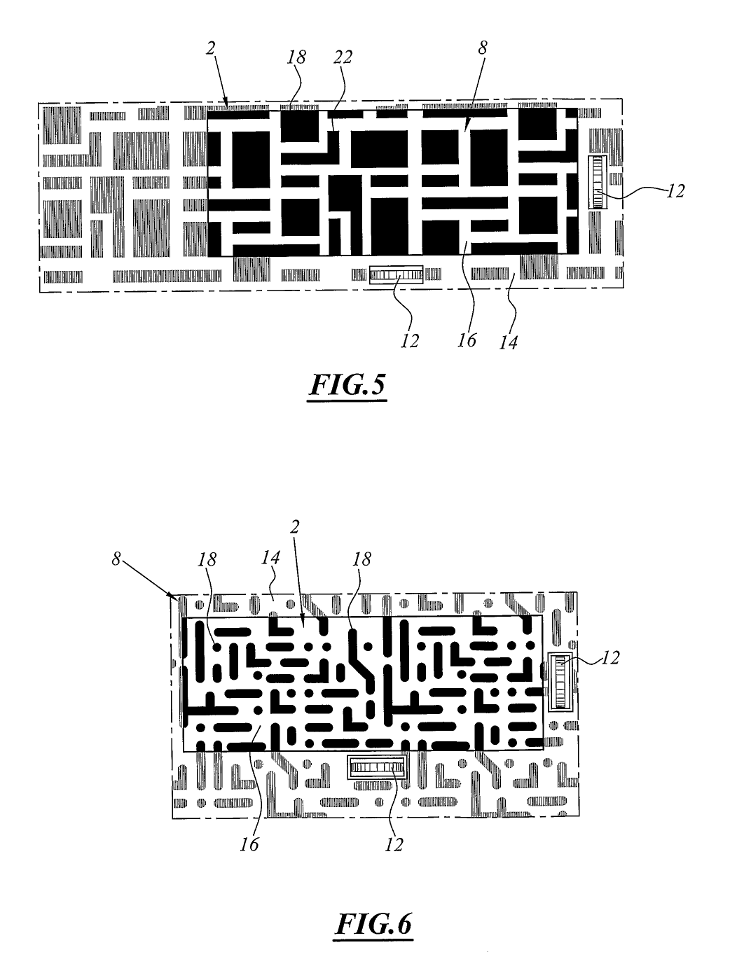

FIGS. 1 and 6 give examples with portions in three directions forming between them angles of approximately 45° and 90°. FIGS. 2 and 4 give examples with two directions forming an angle of approximately 45°. FIGS. 3 and 5 give examples with two directions forming an angle of 90°.

Preferably, the total passage surface area of the openings 18 in the main region 16A of the grille 8 is greater than or equal to 50% of the surface area of this main region 16A. Thus, the grille 8 does not cause any substantial loss of pressure in the stream of air passing through the grille 8.

Preferably, the width of the portions 22 is greater than or equal to 2 mm and the length of the portions 22 is greater than or equal to 3 mm. Any loss of pressure caused by the grille 8 in the stream of air is thus minimized. The directivity of the stream of air is for its part improved without, for all that, impairing the aesthetic appearance of the grille 8 and its function as a mask for the upstream portion of the aerator 2.

In a preferred embodiment, substantially any portion 22 extending in one direction is adjacent to a portion 22 extending in another direction. The directivity of the stream of air is thus improved. These adjacent portions may be separate or may communicate inside the same opening 18.

In the embodiment illustrated in FIG. 6, the aerator 2 also comprises substantially circular openings 18, the average diameter of which is greater than or equal to 3 mm.

Each opening 18 of the grille 8 illustrated in FIG. 1 is formed by a substantially rectangular single portion 22. The openings 18 are arranged in groups in order to define patterns in the shape of circles 24 or sectors of circles 26, enclosed in the rectangular edging of each grille. As described above, the sectors of a circle continue in the decorative trim to form complete circles which are optionally truncated by other circles.

Thus, in FIG. 1, a circle 24 is located entirely opposite the body 10 of each aerator 2, which is not the case of the other three circles which are partially opposite the body 10 and partially in the decorative trim.

The geometry of the grille 8 illustrated in FIG. 2 is formed substantially, in the main region 16A, by a single repeating pattern of opening 18. This opening 18, in the general shape of an elongate Z, comprises a first, horizontal, oblong portion 28, a second, oblique, oblong portion 30 and a third, horizontal, oblong portion 32. The portions 28, 30, 32 have a width of from 2 mm to 10 mm. The horizontal portions 28, 32 have a length of from 3 mm to 40 mm. The oblique portion 30 has a length substantially equal to the length of the horizontal portions 28, 32. The oblique portion 30 forms with the horizontal portions 28, 32 an angle of from 25° to 90°.

FIG. 3 illustrates a geometry of the grille 8 formed, in the main region 16A, by two substantially square repeating patterns 38, 40. A first pattern 38 comprises four substantially rectangular horizontal elongate openings 18, the longitudinal ends of which are rounded. A second pattern 40 comprises four vertical elongate openings 18 having a shape identical to those of the first pattern 38. The patterns 38 and 40 are arranged alternately and in an adjacent manner in the horizontal and vertical directions.

The side of the patterns 38 and 40 is from 3 mm to 80 mm.

The width of the openings 18 is from 2 mm to 10 mm.

FIG. 4 illustrates another example of a possible geometry. The openings 18 of the fixed grille 8 repeat a single pattern in the shape of an elongate S basically comprising three portions. A first crescent-shaped horizontal portion 42, an intermediate portion 44 inclined at approximately 45°, and a second crescent-shaped horizontal portion 46. The intermediate portion connects one end of the first portion 42 to one end of the second portion 46. The opening 18 has a centre of symmetry located substantially in the centre of the intermediate portion 44. The width of the intermediate portion 44 is from 2 mm to 10 mm. The average width of the crescent-shaped portions 42 and 46 is from 2 mm to 10 mm.

FIG. 5 illustrates an example in which the openings 18 are formed by one or more substantially rectangular or square portions 22 of different sizes. These portions confer on the openings 18 a rectangular, square or L-shaped form. The width of the rectangular portions 22 is from 2 mm to 10 mm and their length is from 3 mm to 80 mm.

FIG. 6 illustrates openings 18 formed from various portions 22: horizontal, oblique and vertical rectangular portions. Thus, the openings have rectangular forms in the shape of an elongate S or an elongate Z, or in the shape of an L, a T or an F. The grille also comprises substantially circular openings 18. The average diameter of the circular openings 18 is from 3 mm to 10 mm.

The elongate openings 18 have, in the examples illustrated in FIGS. 1 to 6, an identical cross-section over their entire length and over the thickness of the grille 8. It would, however, be possible to provide that at least some openings 18 widen or taper in the direction of their length to form convergent or divergent openings 18. In a variant, the cross-section of these openings may decrease and/or widen in the direction of the thickness of the grille.

With the invention, it will be appreciated that the aesthetic appearance of the ventilation system is improved without substantially impairing the directivity of the stream of air and without substantially causing a loss of pressure in this stream. In addition, the invention permits a great choice in the aesthetic appearance created for the dashboard.

1-10. (canceled)

11. Forced ventilation system for the passenger compartment of a motor vehicle, of the type comprising an aerator (2) guiding at least one stream of air towards the passenger compartment, the aerator (2) comprising a downstream fixed grille (8) masking the upstream portion of the aerator, characterized in that the grille (8) comprises, in its main region (16A), openings (18) which define a large number of elongate portions (22, 28, 30, 32, 42, 44, 46), these portions being oriented in at least two different directions.

12. Ventilation system according to claim 11, characterized in that the overall passage surface area of the portions (22, 28, 30, 32, 42, 44, 46) oriented in a first direction is substantially equal to the overall passage surface area of the portions (22, 28, 30, 32, 42, 44, 46) oriented in a second direction.

13. Ventilation system according to claim 11, characterized in that two of the directions form between them an angle greater than or equal to 45°.

14. Ventilation system according to claim 11, characterized in that the total passage surface area of the openings (18) in the main region (16A) is greater than or equal to 50% of the surface area of the main region (16A).

15. Ventilation system according to claim 11, characterized in that the portions (22, 28, 30, 32, 42, 44, 46) have a width greater than or equal to 2 mm and a length greater than or equal to 3 mm.

16. Ventilation system according to claim 11, characterized in that substantially any portion (22, 24, 28, 30, 32, 42, 44, 46) extending in one direction is adjacent to a portion (22, 28, 30, 32, 42, 44, 46) extending in another direction.

17. Ventilation system according to claim 11, characterized in that the aerator (2) also comprises substantially circular openings (18), the average diameter of the circular openings (18) being greater than or equal to 3 mm.

18. Ventilation system according to claim 11, characterized in that, inside the same opening (18), a portion (22, 24, 28, 30, 32, 42, 44, 46) extending in one direction communicates with an adjacent portion (22, 24, 28, 30, 32, 42, 44, 46) extending in another direction.

19. Ventilation system according to claim 11, characterized in that the geometry of the grille (8) is formed substantially by a single repeating pattern of opening (18).

20. Ventilation system according to claim 11, characterized in that the openings (18) are in the shape of an elongate S, an elongate Z, an L, a T and/or an F.

21. Ventilation system according to claim 11, characterized in that the grille (8) continues with a similar pattern of openings (18) as the decorative trim of a dashboard (4) of the vehicle.

22. Ventilation system according to claim 11, characterized in that the aerator (2) comprises means for orienting the stream of air, for example a blade or a nozzle, upstream of the grille (8), the means for orienting the stream of air being spaced from the grille (8).

23. Dashboard (4) of a motor vehicle, characterized in that it comprises a ventilation system according to claim 11.

24. Ventilation system according to claim 12, characterized in that two of the directions form between them an angle greater than or equal to 45°.

25. Ventilation system according to claim 12, characterized in that the total passage surface area of the openings (18) in the main region (16A) is greater than or equal to 50% of the surface area of the main region (16A).

26. Ventilation system according to claim 13, characterized in that the total passage surface area of the openings (18) in the main region (16A) is greater than or equal to 50% of the surface area of the main region (16A).

27. Ventilation system according to claim 12, characterized in that the portions (22, 28, 30, 32, 42, 44, 46) have a width greater than or equal to 2 mm and a length greater than or equal to 3 mm.

28. Ventilation system according to claim 13, characterized in that the portions (22, 28, 30, 32, 42, 44, 46) have a width greater than or equal to 2 mm and a length greater than or equal to 3 mm.

29. Ventilation system according to claim 14, characterized in that the portions (22, 28, 30, 32, 42, 44, 46) have a width greater than or equal to 2 mm and a length greater than or equal to 3 mm.

30. Ventilation system according to claim 12, characterized in that substantially any portion (22, 24, 28, 30, 32, 42, 44, 46) extending in one direction is adjacent to a portion (22, 28, 30, 32, 42, 44, 46) extending in another direction.
